(19) United States
(12) Patent Application Publication
(10) Pub. No.: US 2015/0231937 A1
(43) Pub. Date: Aug. 20, 2015

(54) TIRE PRESSURE CONTROL SYSTEM

(71) Applicant: AGCO International GmbH, Neuhausen am Rheinfall (CH)

(72) Inventors: Bernhard Höldrich, Marktoberdorf (DE); Alexander Städele, Marktoberdorf (DE); Frank Kreulich, Marktoberdorf (DE); Christian Pischulti, Marktoberdorf (DE); Benjamin Schmölz, Marktoberdorf (DE)

(21) Appl. No.: 14/472,656

(22) Filed: Aug. 29, 2014

(30) Foreign Application Priority Data
Aug. 29, 2013 (GB) 1315391.1

(51) Int. Cl. B60C 23/10; B60C 29/02; B60C 23/00

(52) U.S. Cl. CPC B60C 23/10; B60C 23/001; B60C 29/02

(57) ABSTRACT

A tire inflation arrangement on a vehicle, said arrangement comprising a rotatable part with a rotatable air passage connected to an air supply and a tire. The arrangement comprises a non-rotatable part on, or through which air from the air supply is conducted. One of said parts is provided with a sealing means for co-operating with a contact surface of the other part. A first valve means (222) and a second valve means (223) are positioned in series along a supply line which extends between the tire and the air supply and each of said valve means (222, 223) is moveable between an open and a closed position in which the flow of air along the supply line is permitted and blocked respectively.

This invention relates to a tire pressure control system (TPCS) having a rotatable air passage. In particular this invention relates to a tire pressure control system with a rotatable air passage on an agricultural vehicle, or machine.

In order to improve efficiency and safety of an agricultural machine, or an agricultural vehicle such as an agricultural tractor, it is necessary to change the pressure of the tires depending on whether the tractor is operating, or on the road. When operating in the field, lower tire pressures are required to reduce ground pressure and compaction and to improve the grip of the tires with the earth. For road work, higher tire pressures are required to reduce rolling resistance (which affects the efficiency of the tractor) and to reduce heat generation (which affects the safety of the tractor). The pressures of the tires may typically be varied by 0.6 bar-2.5 bar when moving between field and road surfaces.

Generally, a tire inflation and deflation system comprises at least one rotatable air passage which is provided on, or within an axle to carry air to and from the tires. The rotatable passage may be connected to a further air duct for carrying air. The rotatable passage extends between rigid, stationary parts (which are connected to the vehicle frame, or form a part of the frame, for example an axle housing) and rotating parts (for example, the wheel hubs). Rotating parts such as wheel hubs are equipped with shaft seals to prevent oil from entering the air guiding area of the rotatable passage. Such systems are described in the Applicant's previous UK patent application No's. GB1021928.5 and GB1021931.9.

Air seals are used to seal the rotatable shaft which comprises the rotatable passage with a non-rotatable part of the vehicle comprising a non-rotatable passage. The non-rotatable part may be the shaft housing in which the shaft and rotatable passage are housed. The rotatable passage is connected to air intake and air out take lines which are connected to an air source. To reduce the wear of the air seals, the sealing lips of the air seals only come into contact with a contact surface of the shaft when the rotatable air passage is charged with air during inflation or deflation. When the rotatable passage is not charged with air, the lips of the air seals are lifted away from the contact surface.

The rotatable passage is connected to a pressurised air supply on the vehicle by means of a main control valve connecting the air supply to one end of the rotatable passage. The other end of the rotatable passage is connected to each tire by a tire valve means. Typically a first main control valve connects the front tires to the air supply and a second main control valve connects the rear tires to the air supply. Each tire is typically provided with a tire valves means located on the tire of the type which comprises a spool and valve housing. Debris or other particles which become lodged between the spool and valve housing can affect the operation of the tire valve means. As the tires are used, they become worn and can become porous allowing particles to enter the tire which can block the valves. Particles can also enter the tire when an external air supply is used to inflate the tires, such as when the vehicle is serviced, or when a new tire is mounted to the vehicle. Trapped particles will prevent the tire valves from closing properly resulting in leakages when the vehicle is shut down. If the vehicle is shut down for a prolonged period of time, for example overnight, the tires may become flat. If the leakage is small, or if the vehicle is not shut down for a prolonged period of time, a driver may not notice that a leakage has occurred and use the vehicle which may be unsafe and dangerous. The tire pressure is typically increased or decreased regularly on an agricultural tractor or agricultural machine as the vehicle or machine moves over different types of terrain in the fields, or moves onto prepared road surfaces. This further adds to the wear and tear of the tire valve means.

It is an object of the invention to address the problems described above by providing an improved tire pressure control system which prevents leakage from the tire through the tire valve means. It is a further object of the invention to provide a means for identifying that a leak has occurred through the tire valve means.

Generally, a tire inflation and deflation system comprises at least one rotatable air passage which is provided on, or within an axle to carry air to and from the tires. The rotatable passage may be connected to a further air duct for carrying air. The rotatable passage extends between rigid, stationary parts (which are connected to the vehicle frame, or form a part of the frame, for example an axle housing) and rotating parts (for example, the wheel hubs). Rotating parts such as wheel hubs are equipped with shaft seals to prevent oil from entering the air guiding area of the rotatable passage. Such systems are described in the Applicant's previous UK patent application No's. GB1021928.5 and GB1021931.9.

According to the invention there is provided a tire inflation arrangement on a vehicle, said arrangement comprising a rotatable part with a rotatable air passage connected to an air supply and a tire, said arrangement comprising a non-rotatable part on, or through which air from the air supply is conducted, one of said parts being provided with a sealing means for co-operating with a contact surface of the other part, characterised in that a first valve means and a second valve means are positioned in series along a supply line which extends between the tire and the air supply, each of said valve means being moveable between an open and a closed position in which the flow of air along the supply line is permitted and blocked respectively.

With this arrangement, the first stop valve provides a safeguard from any leakages from the tire through the second control valve which may not be working correctly owing to trapped debris and particles.

The air supply may be a vehicle mounted air supply or the atmosphere.

Preferably, the tire is connected to the air supply by the first valve means. More preferably, the tire is connected to the air supply by a main control valve. With this arrangement, the first stop valve also prevents any leakage through the main control valve.

Preferably, the supply line comprises a pressure sensor. When the vehicle is shut down, first stop valve and second stop valve are closed securely to prevent any leakage. A pressure sensor monitor is then used to measure the pressure in the supply line between the first stop valve and main control valve during shutdown. A rise in pressure in the supply line indicates a leakage.

When both the first and second valve means are closed the pressure between the main control valve and the tire is preferably measured and if a rise in pressure is detected a warning signal is generated.

When the vehicle is brought into operation following a shutdown, the pressure may be measured independently of the tire pressure adjustment and if a rise in pressure is detected, a warning signal is generated.

Preferably, the vehicle comprises two tires, each tire having an associated second valve means and each second valve means connected to the main control valve by the first valve means.

Preferably, the first and second valve means comprise a stop valve. Preferably the first valve means is closed to prevent leakage from the second valve means.

After each deflation or inflation of the tire, first valve means may be opened and the control valve adjusted to the atmosphere to reduce the pressure level in the air passage to atmospheric pressure. If during monitoring, the pressure exceeds atmospheric pressure, a warning signal is generated since any rise in pressure would be the result of a leakage through second stop valve.

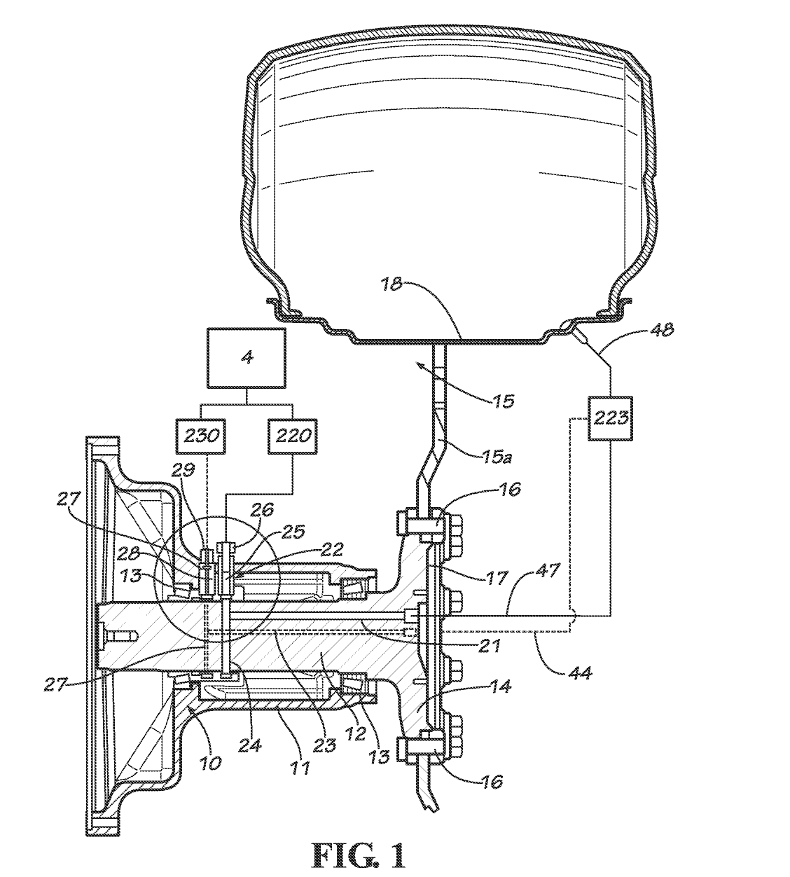

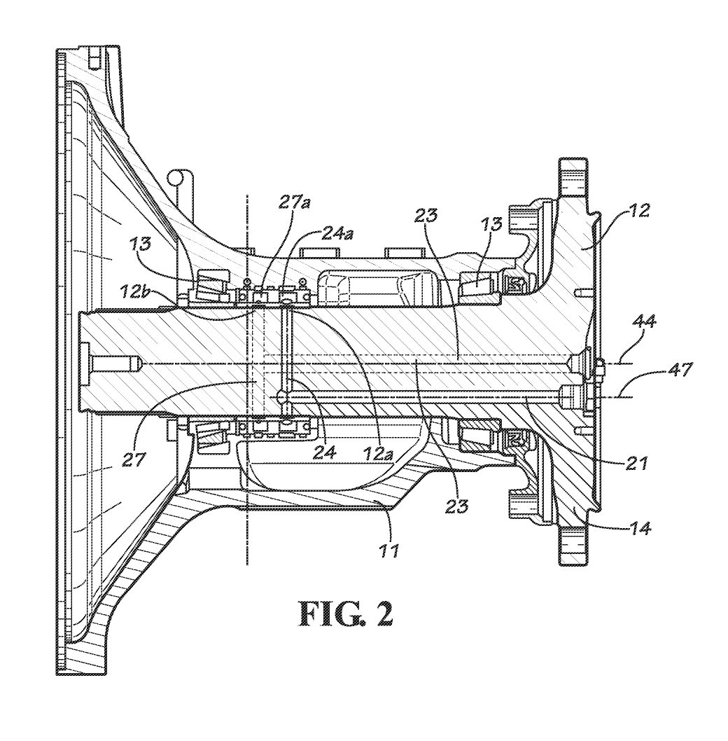

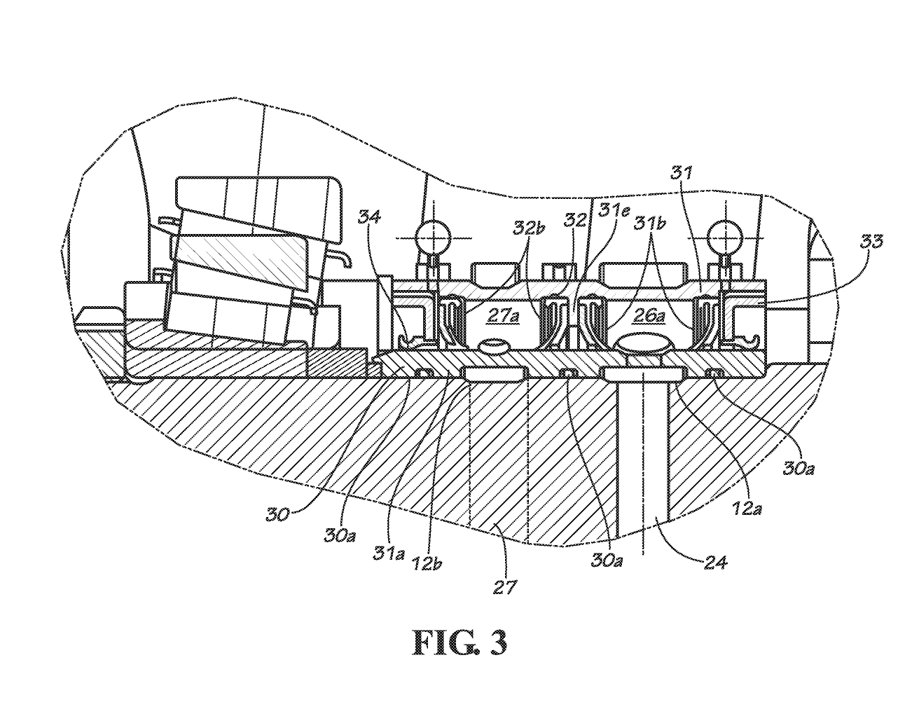

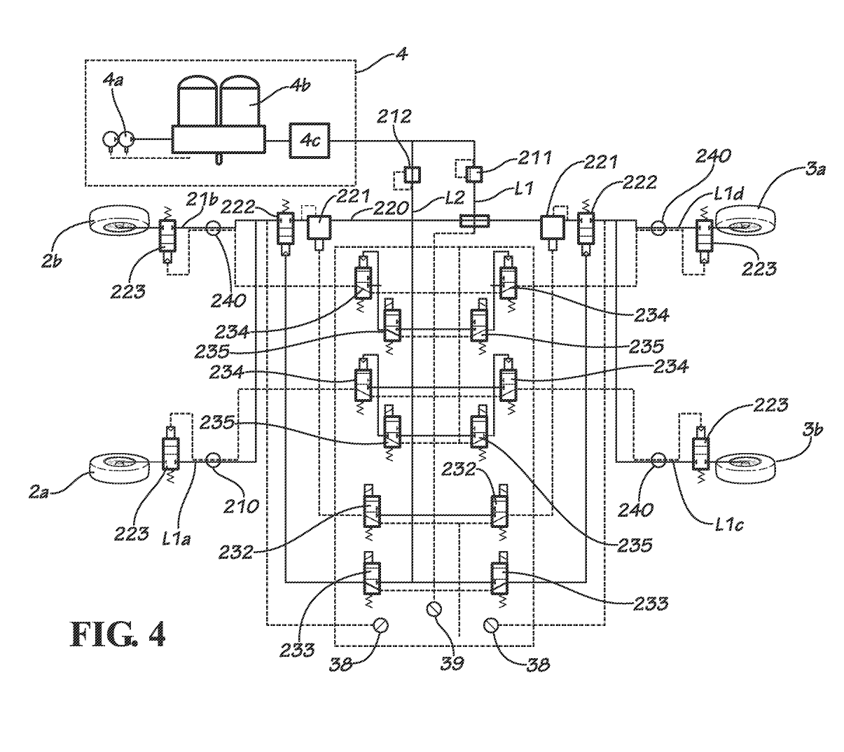

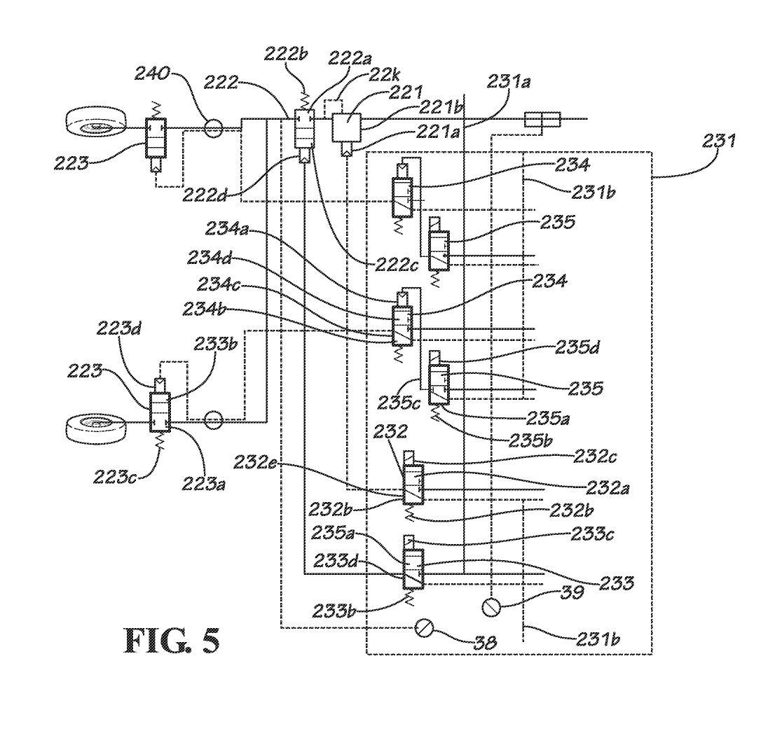

The invention will now be described, by way of example only, with reference to the drawings, FIGS. 1 to 5, in which, FIG. 1 is an axial sectional view through half of a tractor rear axle fitted with a tire inflation feed arrangement in accordance with the invention, FIG. 2 is a section through the rear axle of FIG. 1 on a larger scale, FIG. 3 is part of FIG. 2 on a larger scale, FIG. 4 shows a pneumatic circuit diagram of the tire pressure control system (TPCS) in accordance with the present invention, and FIG. 5 shows the pneumatic circuit diagram of FIG. 4 in further detail.

Referring to FIGS. 1 to 3, a tractor rear axle 10, half of which is shown in cross-section in FIGS. 1 and 2, has an outer trumpet housing 11 within which a driveshaft 12 is supported by bearings 13. Driveshaft 12 terminates in a hub flange 14 to which a wheel disc 15a of a wheel 15 is clamped by bolts 16 and a clamping ring 17.

The wheel disc 15a carries a wheel rim 18 on which a pneumatic tire 19 is mounted.

The present invention is concerned with a tire inflation system for conveying compressed air from a tractor air supply system 4, or for conveying air from the atmosphere to a tire 19. The air is conveyed via air control valves 221 mounted on the tractor through a rotatable passage 240, along line 47, through valve 223 and through line 48 to the tire 19. Air supply system 4 provides compressed air for control circuit 230 and supply circuit 220 which are explained in greater detail in FIGS. 4 and 5.

The tire inflation feed arrangement 22 which is shown in greater detail in FIG. 2 is provided with two rotatable air passages 240. One rotatable passage 240 comprises a first passage 21 and a first radial feed passage 24. The other rotatable air passage 240 comprises a second passage 23 and a second radial feed passage 27. Each rotatable air passage 240 extends within the shaft 12 from hub 14 to a first and second annular axle zone 12a, 12b on the outer periphery of shaft 12 respectively. At the hub end of the shaft, outside of the hub, shaft and shaft housing, first passage 21 connects the rotatable air passage 240 with air supply line 47. Second passage 23 is likewise connected to valve 223 by air supply line 44 outside of the hub, shaft and shaft housing. First radial feed passage 24 extends from first annular zone 12a to first passage. First and second radial feed passages 24, 27 are perpendicularly connected to respective first and second passages 21, 23 which extend inside the enclosed shaft to hub 14. In this way, both the rotatable air passages 240 are fully enclosed within the rotatable shaft 12 and trumpet housing 11.

A contact component 30 surrounds annular zones 12a and 12b and is sealed to shaft 12 by seals 30a. Contact component 30 formed from, or coated with plastics material such as PTFE or could be made from stainless steel, or could be hardened by nitrogen to resist wear. Radial passages 24 and 27 emerge through contact component 30, forming first feed through chamber 24a and second feed through chamber 27a. A holding element in the form of a surrounding casing 31 a provided with sealing means 31, 32 is attached to the axle housing, or non-rotatable part. The sealing means 31, 32 comprises a pair of seals 31b, 32b which when in contact with the contact component 30 provide a through passage with the air passage so that when the rotatable air passage 240 is pressurised, the through passage is also pressurised and ensures the integrity of the seal 31b, 32b with the contact component 30. The pair of seals 31b and 32b come into contact with the contact means 30 on the axle shaft around annular zones 12a, 12b. Pipes 25 and 28 extend from the exterior of the axle housing, or non-rotatable part of the vehicle through the axle housing to the casing 31a. They may be screwed to the casing 31a. With this arrangement there is a free, open passage from the surface of the axle housing, through pipes 25, 28, through the radial zones 12a, 12b, through the rotatable air passage 240 to the hub 14. At the exterior of the axle housing pipes 25 and 28 are provided with pipe fittings 26, 29 which are connected by respective lines to supply circuit 220 and control circuit 230. Pipes 25, 28 may be made from stainless steel, or, brass, or some other non-corroding material. Pipes 25, 28 and pipe fittings 26, 29 and respective seals to provide air-tight connection are not shown in FIG. 3 for clarity reasons and as they are not relevant for the invention.

Sealing means 31 is mounted in a casing 31a into which pipe 25 is screwed. Sealing means 31 which comprises a pair of seals 31b on either side of first feed through chamber 24a are forced into sealing contact with the contact member 30 when first feed through chamber 24a is pressurised and thus seals the flow of air to passages 21, 24. A shaft seal 33 is also provided in casing 31a to prevent the ingress of oil and dirt around axle 12.

Similarly, second sealing means 32 is also mounted in casing 31a into which pipe 28 is screwed. Sealing means 32 includes a pair of seals 32b which are provided on either side of second feed through chamber 27a so that when second feed through chamber 27a is pressurised, seals 32b are forced into sealing contact with the contact component 30 to seal the flow of air through passages 23, 27. A shaft seal 34 is also provided in casing 31a to prevent the ingress of oil and dirt around axle 12.

The two sealing means 31 and 32 are located side by side with shaft seals 33 and 34 axially outermost relative to the two annular axle zones 12a and 12b. A spacer 31e is built into casing 31a between the sealing means.

Use of a separate contact component 30 allows relatively easy replacement of the contact member if it becomes worn due to the contact pressure of sealing means 31 and 32 without the need for replacement of the expensive wheel flange 14 and associated shaft 12.

Although in the embodiment described the seals 31 and 32 are carried by housing 11 and the contact member 30 is mounted on shaft 12, this arrangement could be reversed if desired. Furthermore, any other sealing means in which the sealing contact is provided by pressurising the respective passage could be used instead of the embodiment shown in FIGS. 1 to 3. Additionally, the radial passage as could be replaced by an axial feed through arrangement as shown in the applicant's patent applications GB1016661.9 or GB1016662.7. FIG. 4 details the supply and control circuits 220 and 230 respectively on a tractor 1. The tractor 1 is provided with: left and right front wheels 2a, 2b, left and right rear wheels 3a, 3b, a tire pressure control system (TPCS) and a tractor air supply system 4 comprising a compressor 4a, air drier 4b, a protection valve means 4c.

The tractor air supply system 4 has a compressor 4a which supplies consumers via an air drier 4b. The air drier 4b includes a reservoir to store compressed air and a granule cartridge to extract water from the air. A pressure limiting valve restricts pressure levels to a maximum of approximately 8.5 bars. Typical consumers are, for example, the tractor braking system, the trailer braking system, or a front suspension (not shown). These consumers are primary consumers as their function is relevant for safety. A secondary consumer is the TPCS. A protection valve means 4c balances the pressure required to be supplied to the primary set of consumers and will cut the supply to any consumer should a consumer develop a leak. In this way, the integrity of the remaining primary consumers is maintained. Furthermore, protection valve means 4c ensures that supply to primary consumers is prioritised over the supply to secondary consumers, such as the TPCS.

The tractor air supply system 4 solely serves the purpose to supply air to the TPCS at a specific pressure level, for example 8 bar and at a sufficient air flow to ensure acceptable inflation time during operation. The term air flow is taken to mean the volume of air per unit time. The tractor air supply system 4 could be replaced by any other air supply system, for example, a system such as that described in the Applicant's published patent application W0011/001261, or EP2 340 974 which serves the same purpose and has a compressor in addition to an internal compressor.

The tractor air supply system 4 is connected to the TPCS via an excess flow valve 211 which is set to a minimum pressure level of for example, between 7.1 to 7.5 bars. If the pressure level in the line L1 drops below the set level, for example, if a break in the line occurs, the connection is blocked to protect the tractor air supply system 4 from complete air discharge.

A second connection between the air supply system 4 and TPCS is further provided via a pressure relief valve 212 which limits the pressure in line L2 to a level between 4.5 to 5 bars. The need for this second pressure level is explained later on.

Generally, the TPCS comprises two separate circuits which represent two functions of the system. One circuit is the supply circuit 220 which is depicted in FIGS. 4 and 5 with continuous lines and which provides an air supply to the tire. This circuit must be capable of high air flow rates at a maximum pressure level to ensure fast inflation of a tire. A second circuit, control circuit 230 which is shown by the broken line is provided for activating the deflation and inflation process by components controlled by the pilot valve of the supply circuit 220. Compared to the supply circuit 220, the pressure level is reduced by pressure relieve valve 212. In addition, all components of the control circuit are specified for smaller air flow as the pilot function requires only small air flows. The lower pressure level and air flow in control circuit 230 enables the use of smaller and cheaper components, especially valves, which improves procurement, costs and installation space. Furthermore, the lower pressure level enables higher accuracy when sensors are installed, as the accuracy is decreased with a greater range of operation.

The TPCS is similar for the front and rear axle (and mostly the same for each tire).

FIG. 5 shows FIG. 4 in greater detail in which the components related to rear wheels 3a, 3b and to the tractor air supply system 4 have been omitted.

The supply circuit 220 is provided with two main control valves 221 (one assigned to front tires 2a,2b and the other assigned to rear tires 3a, 3b) to regulate the pressures in the tires. The main control valves have two different operating conditions and may be controlled pneumatically, or electronically. In a first condition, the supply lines (that is the air supply lines connected to line L1) are connected (for inflation) and a second condition in which the supply lines are connected to ambient atmosphere (for deflation). Tire supply lines L1a, L1b, L1c and L1d, connect the first stop valves 222 to each tire. Each of the first stop valves 222 is connectable to supply line L1 for inflation and to the atmosphere for deflation.

In accordance with the invention, each tire is connected to first stop valve 222 via a second stop valve 223 associated with each tire. The tires 2a, 2b on the front axle are connected to one first stop valve 222 and the tires 3a, 3b of the rear axle are connected to another first stop valve 222. Each first stop valve 222 connects the main control valve 221 to a second stop valve 223 on each tire. The first stop valve 222 is biased by a spring means 222b and can be moved into a position 222a to close the valve (as shown in FIG. 5) and block air flow, or can be moved to an open position 222c to allow air flow. The valves 222 may be moved into the open position 222c against the force of spring 222b pneumatically by charging port 222d.

Air passing from the air supply 4 will pass through main control valve 221 and then flow through first stop valve 222. From first stop valve 222, the supply lines branch off to the respective tires 2a, 2b and 3a, 3b. Through the supply line in each branch air will pass through first radial feed passage 24 and passage 21 (being part of the rotatable passage 240) for inflating and deflating a tire as shown in FIGS. 1 and 2.

Second stop valves 223 are also controlled pneumatically and can be moved into two positions, open and closed. A closed position 223a is shown in FIGS. 4 and 5 in which it is biased by spring 223c to block the air flow to and from the tire. By charging port 223d, the valve can be moved against the spring 223c into an open position 223b to connect the interior of the tires 2a, 2b, 3a, 3b to the supply line. A pilot valve manifold 231 (described later on) comprises two pressure sensors 38, 39. First pressure sensors 38 are provided in the supply line between first stop valve 222 and second stop valve 223. Second pressure sensor 39 is connected in the line before first stop valve 222 and main control valve 221 of each axle.

During operation of the tractor and when the TPCS is in stand-by mode, second stop valves 223 are in a closed position 223a to close the tire volume.

The term operation of the vehicle or machine is defined herein as meaning that the vehicle or machine is in a condition in which its system or systems are sufficiently powered to automatically inflate or deflate a tire, or detect a change in pressure of a tire. The term shut down of the vehicle is defined herein as meaning a condition in which the vehicle, or machine, is in a condition that its system or systems are not sufficiently powered to automatically inflate or deflate a tire, or detect the pressure of a tire.

Referring to TPCS the term stand-by mode is defined herein as meaning that the TPCS is in a condition wherein no change in tire adjustment is made by the driver, or an automatic control system but measurements or monitoring functions may be performed. The TPCS active mode is a condition in which the tire pressure is being adjusted.

If the vehicle is not in operation (that is, it is shut down), TPCS is also not in operation since supply of any electric, or pneumatic energy supply is cut. Consequently, in this condition, the TPCS is not in stand-by or in active mode.

If the tire pressure is adjusted (either by manual input by the driver or an automatic control system), second stop valve 223 and first stop valve 222 are opened.

First stop valve 222 closes the connection between the main control valve 221 and second control valve 223 and thus provide a safeguard from any leakages from the tire through second control valve 223 which may not be working correctly owing to trapped debris and particles. Valve 222 also protects against any leakage through main control valve 221.

When the vehicle is shut down, first stop valve 222 and second stop valve 223 are closed securely and prevent any leakages. After any deflation or inflation process which results in second stop valve 223 being in a closed position 223a, the first stop valves 222 are brought into an open position 222c and a main control valve is moved to an ambient connection (that is the atmosphere) so that pressure is discharged from the supply line. The discharge ensures that the rotary passage is free of pressure and the air seals are not in contact. To detect whether there has been a leakage during shut down, first stop valve 222 is then closed again (position 222a). Pressure sensors 38 monitor the pressure in the supply line between the first stop valve and main control valve during shutdown and if the pressure exceeds atmospheric pressure, a warning signal is generated since any rise in pressure would be the result of a leakage through second stop valves 223. The driver is made aware of the warning signal when the vehicle is put into operation again. Alternatively, just prior to shut down, when pressure through pressure sensors 38 can be recorded, the pressure values are stored in the tractor control unit. When the vehicle is in operation, the pressure in the supply line is measured again and compared with the recorded value. If the two values are not the same, a warning signal is generated and the driver made aware.

To inflate a tire main control valve 221 is adjusted so that the tire is connected to the tractor air supply system 4 and the tire is charged with air. The pressure adjustment may be done in two ways. One way is that main control valve 221 is fully opened until the tire pressure, monitored by first pressure sensor 38, reaches the desired value. In another way, main control valves 221 may be opened to a position corresponding to the desired pressure. The tire pressure is fed back via line 221c and main control valves 221 closes when the value is reached. In case of deflation, main control valve 221 is moved into a position in which port 221b is connected with the atmosphere. Air can be discharged to the atmosphere until the desired pressure value which is monitored by first pressure sensor 38 is reached.

Furthermore, the feedback via line 221c ensures that the pressure level in the supply circuit after the main control valve 221 does not exceed 4.5 to 5 bar as the pressure in line 221c counteracts against the pressure coming from pilot circuit via port 221a which is set to a maximum of 4.5 to 5. This balancing ensures that the tires are not charged with more than 5 bar representing an acceptable level.

So the supply circuit 220 of the TPCS is provided with two different pressure levels: In between supply system 4 and main control valve 221, the pressure level, hereinafter referred to as the tractor supply pressure, can reach up to 8.5 bars. In between main control valve 221 and tire 2a, 2b, 3a, 3c, the pressure level is limited to 5 bars; this pressure is hereinafter referred to as the TPCS supply pressure.

As described above, the valves 221, 222 and 223 are controlled pneumatically. The control function is provided by control circuit 230. All means for controlling the valves are integrated in a pilot valve manifold 231 as shown by the dotted lines. Pilot valve manifold 231 is connected via port 231a to pressure relief valve 212 to receive air at a reduced pressure level of between 4.5 to 5 bars. Ports 231b enable the discharge of air to the atmosphere. Each valve installed within pilot valve manifold 231 is connected to the respective ports to supply air or to discharge air to the atmosphere. Pilot valve manifold 231 is also connected to the tractor control unit (not shown) to control the TPCS. Alternatively, pilot valve manifold 231 may be equipped with an own control unit receiving required parameters from the tractor control unit.

Main control valves 221 are pilot controlled by first pilot control valves 232 which are designed as a three port/two way valve. Valves 232 move into position 232a against spring 232b when solenoid 232c is activated. When port 232d is charged with air, port 221a is also charged with air so that main control valve 221 is opened. The valve is biased in the second position 232e shown in the figures by spring 232b wherein port 232d is connected to the atmosphere so that main control valve 221 is moved to a position in which port 221b is connected with the atmosphere (for deflation).

In a mid-position, main control valve 221, blocks the connection. The mid position is provided if the pressure charged via line 221c is balanced with the pressure charged via port 221. Due to the simple and cheap design of the valve, this mid position cannot be adjusted permanently, so that valve 221 cannot be provided for controlled blocking of the connection.

Stop valves 222 are pilot controlled by second pilot control valve 233. Depending on its position, the stop valves 222 are opened or closed. The position 233a of second pilot control valve 233 shown in FIGS. 4 and 5 is biased by spring 233b. If solenoid 233c is activated, port 233d and thereby port 222d is charged with air so that stop valves 222 are opened to position 222c. In the second position 233e, port 233d and thereby port 222d is connected to the atmosphere and stop valves 222 are moved into position 222a by spring 222b so that air flow through stop valves 222 is blocked.

As second stop valves 223 are installed on the tires, the connecting pipes to the pilot valve manifold 231 are much longer compared to the connection of main control valves 221 and first stop valves 222. The overall resistance due to the rotatable passages 240 and longer lines are larger; this results in that further third pilot control valves 234 are provided which have a larger air flow capacity. This greater air flow increases the pressure peak through the rotatable passage as the second stop valve blocks the air flow (when in position 223a) so that the back pressure increases the pressure level in the feed through passage. As valves with the demanded larger air flow capacity are not available with solenoid control or are very expensive and spacious, third pilot control valves 234 are also pneumatically pilot controlled and connected to a fourth pilot control valve 235 which is similar (referring to air flow capacity) to first pilot control valve 232 and second pilot control valve 233. Fourth pilot control valves 235 is again solenoid-controlled. Thereby third pilot control valves 234 and fourth pilot control valves 235 provide a two-stage pilot control for second stop valves 223 working as following: Fourth pilot control valves 235 is kept in position 235a by spring 235b so that port 235c is connected to ambient. As port 235c is connected to port 234a, third pilot control valves 234 is kept in position 234b. In this position, port 234c is connected to ambient so that second stop valves 223 remain in blocked position 223a. If solenoid 235d moves fourth pilot control valves 235 in position 235e, port 234a is charged with air moving third pilot control valves 234 into open position 234d. In this position, port 234c is connected to air source so that second stop valve 223 is moved to open position 223b. Third pilot control valves 234 and fourth pilot control valves 235 are provided for each tire.

The details related to the pilot control within the pilot valve manifold 231 in general are not relevant for the invention and may be designed in various layouts. Solenoid-controlled valves replacing valves 221, 222 and 223 may obviate the need of any pilot control.

During inflation or deflation the rotatable air passage 240 and through passages are charged with a high air flow, but a low pressure level. This is because the maximum tire pressure of a standard tractor tire is about 2 to 3 bar but the pressure of the air supply may be around 4.5 bar. As a consequence, the seals 31b, 32b are pressed into sealing contact under a low pressure. This pressure level can be varied depending on the tire pressure target value, or the required air flow (which can be very low under certain conditions, for example, if only a small pressure difference is necessary). It is difficult to design a seal which can be pressed sufficiently hard to make good contact with the contact component without being easily worn when used for every operating condition. This affects the function of the seals 31b, 32b in the rotatable passage 240.

To ensure a suitable pressure level in the rotatable passage 240 before inflation or deflation of tires, the pressure level in the rotatable passage 240 is raised by the following method:

1. Tractor control unit recognise the need of pressure adjustment and the process is initiated

2. Second stop valves 223 are kept in closed position 223a.

3. Main control valves 221 are adjusted so that tire is connected to the tractor air supply system 4 and the pressure level within the rotatable passage 240 and/or first feed through chamber 24a is raised. This step may be time controlled (by assuming that after a pre-determined time, the desired pressure level is reached), or by using pressure sensors 38. Pressurisation continues either until the pre-determined time is reached, or the desired pressure level is reached. At this stage sealing means 31, 32 are firmly pressed against contact component 30 providing a good seal between the rotatable and non-rotatable parts. This step is provided both for inflation and deflation of the tires.

4. If the pressure level in the rotatable passage 240 is within the defined pressure range, second stop valves 223 are moved to the open position 223b.

Main control valve 221 is then adjusted to obtain the desired tire pressure as described above. The closure of stop valve 223 prior to any pressure adjustment ensures that there is a high pressure level between the seals 31b, 32b and therefore a proper sealing contact. After opening stop valve 223 for starting inflation or deflation, the pressure level may fall but the sealing contact is still sufficient due to the previous closure of valve 223. This method can be used prior to both inflation and deflation of the tire without changing any structural components, or steps of the method. (For the rotatable passage of the control line 44, this function is not required as the control line 44 is pressurised to move stop valves 223 to position 223b resulting in that the air flow is initially blocked in line 44 so that the pressure level in rotatable passage increases rapidly).

Both methods ensure that the rotatable passage 240 and through passage between sealing means 31, 32 is pressurised which therefore ensures the integrity of the seals 31b, 32b with the contact component 30. This thus provides a good seal between the rotatable and non-rotatable parts of the arrangement before the pressure in the tire is adjusted.

When pressure sensors 38 are provided, the deflation or inflation process is only activated when the pressure in the rotatable passage 240 is within the defined pressure range. If the pressure level is not maintained, the system may generate a warning for the driver. This ensures that that malfunction is detected which increases functional safety and efficiency.

In an alternative embodiment of the invention, the stop valves 223 are replaced by lockable check valves. These lockable check valves are known in prior art and work as explained below:

The check valve is spring biased and connected to the control circuit 230 for pilot control. Generally a check valve comprises a piston-like closure member in form of a cone or ball which is biased by a spring. The piston is moved directly by the supply circuit 220. A further piston is charged by control circuit 230 (also called the pilot control). This additional piston acts on the closure member is mainly provided to offer a ratio (to enable low pilot pressure) or to avoid influence of both circuits.

The check valve normally blocks the flow of air from the tire 2a, 2b, 3a, 3b back to the supply circuit 220 to prevent any unmeant deflation. During inflation, the supply circuit 220 provides a higher pressure (compared to the tire) so that the check valve is opened against spring. The tire can be charged with air to reach the desired tire pressure. For deflation, the control circuit 230 pneumatically opens the check valve against the spring so that air can be discharged from the tire. In this case the spring is designed to be opened solely by the pressure in the supply circuit 220.

In accordance with an alternative embodiment, the design of known check valves is adapted in that the spring is designed so that the check valve cannot be opened by pressure supplied in the supply circuit 220 but only by a predetermined pressure in the control circuit 230. Referring to the design, the effective surface of the pistons is specified in that the size on the supply circuit 220 is small compared to the size on the control circuit 230, so that the check valve can only be opened (in one direction) by a pre-determined pressure in the control circuit but not by the operating pressure in the supply circuit.

Prior to any inflation or deflation, the check valve is kept in a locked position while the supply line is charged to a pre-determined pressure level without being able to open the connection to the tire.

In the embodiment shown in FIGS. 1 to 5, the invention is realised by installing main control valves 221 and second stop valves 222 in series due to reasons described above. It is envisaged that the invention could also be realised by combining the function of both valves 221, 222 into one valve, either 221 or 222.

In the embodiment shown in FIGS. 1 to 5 the rotatable air passage 240 pneumatically connects the non-rotatable trumpet housing 11 and the rotating driveshaft 12. It is envisaged that any other rotatable air passage of a non-rotatable part of the vehicle, or a rotating component connected with the tire falls within the scope of the invention. The rotatable passage may, for example be provided on the outside of the tire and be connected to the air supply via pipes, or hoses.

1. A tire inflation arrangement on a vehicle, said arrangement comprising a rotatable part with a rotatable air passage connected to an air supply and a tire, said arrangement comprising a non-rotatable part on, or through which air from the air supply is conducted, wherein one of said parts is provided with a sealing means for co-operating with a contact surface of the other part, characterised in that a first valve means (222) and a second valve means (223) are positioned in series along a supply line which extends between the tire and the air supply, each of said valve means (222, 223) being moveable between an open and a closed position in which the flow of air along the supply line is permitted and blocked respectively.

2. A tire inflation arrangement as claimed in claim 1 wherein the air supply is a vehicle mounted air supply or the atmosphere.

3. A tire inflation arrangement on a vehicle according to claim 2 wherein the tire is connected to the air supply by the first valve means (222).

4. A tire inflation arrangement on a vehicle according to claim 2 wherein the tire is connected to the air supply by means of a main control valve (221)

5. A tire inflation arrangement on a vehicle as claimed in claim 1 wherein the supply line comprises a pressure sensor (38).

6. A tire inflation arrangement as claimed claim 5 wherein when both the first and second valve means (222, 223) are closed, the pressure between the main control valve (221) and the tire is measured and if a rise in pressure is detected, a warning signal is generated.

7. A tire inflation arrangement as claimed in claim 5 wherein when the vehicle is brought into operation following a shutdown, the pressure is measured independently of the tire pressure adjustment and if a rise in pressure is detected, a warning signal is generated.

8. A tire inflation arrangement on a vehicle as claimed in claim 1 wherein the vehicle comprises two tires, each tire having an associated second valve means (223) and each second valve (223) means connected to the main control valve (221) by the first valve means (222).

9. A tire inflation arrangement as claimed in claim 1 wherein the first and second valve means (222, 223) comprise a stop valve.

10. A tire inflation arrangement as claimed in claim 1 wherein first valve means (222) is closed to prevent leakage from the second valve means (223).

11. A tire inflation arrangement as claimed in claim 1 wherein after each deflation or inflation of the tire, first valve means (222) is opened and the main control valve (221) is adjusted to the atmosphere to reduce the pressure level in the air passage.
